(19) United States
(12) Patent Application Publication
(10) Pub. No.: US 2025/0347350 A1
(43) Pub. Date: Nov. 13, 2025

(54) Safety Device

(71) Applicant: Hydac Technology GmbH, Sulzbach / Saar (DE)

(72) Inventors: Peter Kloft, Ransbach-Baumbach (DE); Torsten Kusserow, Thörnich (DE); Jens Holger Köhne, Saarbrücken (DE)

(73) Assignee: Hydac Technology GmbH, Sulzbach / Saar (DE)

(21) Appl. No.: 18/866,745

(22) PCT Filed: Jun. 6, 2023
(86) PCT No.: PCT/EP2023/065067

§ 371 Date: Nov. 18, 2024

(30) Foreign Application Priority Data
Jun. 10, 2022 (DE) 10 2022 002 089.0

(51) Int. Cl. F16K 17/40; F16B 23/00

(52) U.S. Cl. CPC F16K 17/403; F16B 23/00

(57) ABSTRACT

A safety device is disclosed, consisting of a screw body with a screw head, which is connected to the screw body in one piece and forms a rotary-drive part, and with a thread, which is connected to the screw head in one piece and forms a securing part, and also with a rupture device, which is arranged in a channel of the screw body, wherein a sight glass is accommodated entirely within the channel of the screw body, together with the rupture device, and forms an inspecting device for assessing the state of the rupture device.

### CROSS-REFERENCE TO RELATED APPLICATIONS

This application claims priority to German Patent Application No. DE 10 2022 002 089.0, filed on Jun. 10, 2022 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a safety device.

DE 10 2015 014 797 A1 A discloses a safety device having a connection point for a pressure accumulator, which is connected via said connection point to a rupture device on the gas side, which can be triggered by a controllable force element and, in the triggered state, allows the pressure accumulator to be emptied on the gas side.

A pyrotechnic object can be used as a force element in this process, said object deforming or destroying a wall piece of a housing in the event of a propellant charge being ignited accordingly such that the rupture device accommodated therein is triggered, or destroying the rupture disc of the rupture device by means of an actuating pin. This opens up the possibility of responding to hazardous situations, for example in the event of a fire, by reducing pressure before a hazardous excess pressure is able to arise, such as due to overheating in the event of a fire. Ultimately, in this case, when the safety device responds, the connected hydraulic circuit is rendered inoperable along with its components.

### SUMMARY

A need exists to provide a comparable safety device with which the connected hydraulic circuit remains operable along with its components when the safety device responds.

The need is addressed by the subject matter of the independent claim(s). Embodiments of the invention are described in the dependent claims, the following description, and the drawings.

### BRIEF DESCRIPTION OF THE DRAWINGS

FIG. 1 shows a perspective plan view of an example safety device in its entirety;

FIG. 2 shows a longitudinal section through the example safety device according to FIG. 1;

FIG. 3 shows a perspective plan view of an example hydraulic component with a safety device according to FIG. 1 and 2 inserted from the upper side; and

FIG. 4 shows a longitudinal section through the hydraulic component according to FIG. 3.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a safety device is provided, comprising a screw body with a screw head, which is connected to the screw body in one piece and forms a rotary-drive part, and with a thread, which is connected to the screw head in one piece and forms a securing part, and also with a rupture device, which is arranged in a channel of the screw body, wherein a sight glass is accommodated entirely within the channel of the screw body, together with the rupture device, and forms an inspecting device for assessing the state of the rupture device. Correspondingly, if a predefinable pressure limit value is exceeded, the rupture device yields as a safety element with the result that the channel of the securing device fills with fluid until the inspecting device attached opposite the rupture device ‘responds’ and reports the failure. In this manner, relatively simple means can be used to establish that, for example, an excess pressure that is detrimental to the hydraulic valves under certain circumstances has arisen in the hydraulic circuit with its connected components, said excess pressure having accordingly caused the rupture device to rupture and the inspecting device then alerts the operator or the maintenance staff respectively to the undesirable excess pressure or overload situation that has arisen, but without disabling the connected hydraulics or otherwise adversely affecting their functionality. The sleeve for the rupture and inspecting device is manufactured from one piece, particularly from metallic material, and is thus very strong. As such, there are no leaktightness issues leading to the occurrence of undesirable leaks. The safety device can also be permanently secured in or on third-party components such as valve blocks, fluid connection bodies, etc.

In some embodiments, it is provided that the rupture device comprises a rupture disc, which is securely connected to the screw body in a channel thereof as an independent component, in particular securely welded along an outer circumferential line of the rupture disc. The rupture disc generally consists of a thin-walled metal membrane, also of corrosion-resistant stainless steel material, the membrane thickness of which is selected such that the membrane or the rupture disc respectively fails in the event of a predefinable excess pressure threshold value. Due to the linear connecting seam, the rupture disc is secured at the edges like a vibration membrane and, as such, is designed as a kind of cantilever, which relieves the rupture disc when corresponding pressure loads occur, even in the form of vibrations.

If the inspecting device is formed by a sight glass, this allows a simple visual check to be made to establish whether the rupture device has failed, precisely in that hydraulic medium enters the channel of the securing device via the ruptured rupture disc, which can be ascertained by visual means from outside via the sight glass. As the hydraulic fluid is often coloured, for example with a red colouring, failure can be ascertained accordingly by visual means even in the event of difficult environmental lighting conditions.

The inspecting device itself could also be formed by an ultrasound detector or comprise a capacitive measurement device or a sensor system for determining electrical conductivity; only the corresponding inspecting or detection devices require electrical current for evaluation and for transmitting information, which cannot always be regarded as beneficial from a safety perspective in interaction with the combustible hydraulic medium, which means that visual inspection without electrical current meets correspondingly higher safety requirements under all circumstances. In particular, the safety device is so inherently stable that no additional discharge channels are required on the housing side. This therefore has no parallel in the prior art. The rupture disc transitions almost seamlessly into the securing device and is securely anchored to the securing device such as to accordingly span the inlet channel in a pressure-tight manner.

For particularly reliable operation and in some embodiments, it has been shown to be beneficial if the rupture disc spans a free end of the channel on the inside, said end being adjacent to a thread runout, which is arranged on the side of the screw body facing away from the screw head. For example, the rupture disc is furnished with a curvature originating from the securing point of said rupture disc in the channel of the screw body, said curvature protruding in the direction of the sight glass. In this manner, in the event of rupture, a reliable fluid flow in the direction of the recessed protrusion with a uniform force application is guaranteed such that failure can be reliably calculated and the rupture disc yields or fails respectively at precisely defined limit values.

It is for example also provided that the channel is formed by a hollow-cylindrical recess in the screw body, which passes completely through the screw body, retaining the same diameter, and emerging into the environment at its free ends which are opposite one another. The diameter of the rupture disc and the diameter of the sight glass, which is for example designed to be cylindrical, is identical. Due to the constant channel diameter, pressure peaks that might have a detrimental effect in the event of failure are unable to build up inadvertently inside the channel.

In some embodiments, it is provided that the sight glass is designed as a solid cylinder and, when inserted in the channel, ends flush with the upper side of the screw head and has an insertion length in the channel such that the sight glass, in a notional extension, ends flush at the level of a (lower) side of the screw head which is adjacent to and opposite a further runout of the thread. As a result, this leads to a self-contained body with a symmetrical structure and uniform pressure distribution in the event of damage.

In some embodiments, it is provided that the sight glass is formed of a glass material, such as, for example, a laminated safety glass, a soda-lime glass, a borosilicate glass, a glass ceramic, or a quartz, or sapphire glass. The choice of possible glass materials is such that the sight glass can be chosen specifically for the respective application with regard to pressure resistance, temperature resistance, transparency and material resistance in view of the liquids and/or gases arising in hydraulic circuits. In particular, the specified types of glass can be ground on their exposed end faces for an improved visual appearance and for example also polished in between times. As such, this then eliminates disruptive scratches and irregularities and creates a visually appealing surface that is easy to clean if required. In this manner, using the sight glass requires no maintenance and permits a reliable visual inspection of the inside of the channel within the securing device. Furthermore, the sight glass can be furnished with optical properties such as magnification, a coating and/or prismatic properties. The use of borosilicate glass has also been proven to be particularly beneficial in this context.

In some embodiments, it is provided that the securing device is formed of a metallic material, such as corrosion-resistant stainless steel, for example, which surrounds the glass material, which are both heated together during production to a temperature at which the glass material is liquid and runs onto the metallic material in contact with said material such that, when it subsequently cools down, the glass material sets inside the channel of the securing device and is clamped by the metallic material of the securing device in an annular manner. In this manner, a fluid-tight insertion of the sight glass in the securing device is achieved, forming a force-locking connection between the glass material of the sight glass and the metallic material of the securing device. Due to the mechanical pretensioning, a metal-fused sight glass of this kind acts as a tough material and otherwise displays increased safety compared to a thermally pretensioned sight glass.

The respective sight glass is incorporated in a screw insert in the form of an insert solution and corresponding screw inserts can be manufactured in large quantities in a standardised design and as such can also be inserted retrospectively in pre-existing delivered hydraulic systems as retrofit kits if necessary.

It has proved to be particularly functionally reliable if the sight glass in some embodiments ends flush with the upper side of the engagement part, wherein the sight glass is designed as a solid, pressure-tight cylinder with an engagement depth in the channel that is greater than or equal to the diameter of the sight glass. In this manner, this guarantees that the sight glass is anchored in the screw-in part in a particularly pressure-tight manner.

To ensure a functionally reliable inspection, the free length of the channel in the screw-in part is selected to be greater than or equal to the length of the male thread of the screw-in part, which surrounds the channel which is designed to be hollow-cylindrical in a concentric manner, said channel receiving the hydraulic medium until it comes into contact with the lower side of the sight glass after the rupture disc fails and thus reporting failure at the sight glass as the visual inspecting device.

The disclosure further relates to a hydraulic component, for example as a component of an overall hydraulic system, which comprises a housing in which at least one pressurised fluid channel runs, wherein the safety device as described herein is secured in a pressure-tight manner in the component housing and establishes a fluid-conveying connection between the rupture device and the pressurised channel in the housing such that, if a safety-critical threshold pressure value in the fluid channel is exceeded, the rupture device yields and accordingly fluid passed into the safety device can be ascertained by the inspecting device, particularly in the form of the sight glass, such that overloading, which may also comprise a failure, can accordingly be detected immediately.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS.

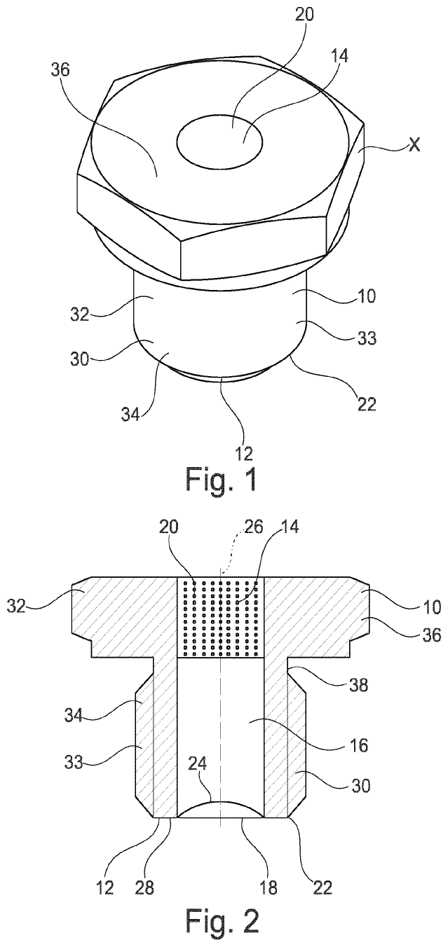

FIG. 1 shows the safety device in a perspective view in its entirety. The safety device comprises a securing device in the form of a screw body 10 with a rupture device 12, which is arranged at the lower end of the securing device in the view shown on FIG. 1. The securing device also comprises an inspecting device 14 on its upper side. As shown in the longitudinal section illustrated on FIG. 2 in particular, a cylindrical channel 16 is provided inside the screw body 10, which, in the view shown on FIG. 2, is delimited on its lower side by the rupture device 12 and on its upper side by the inspecting device 14, which, as such, are arranged at a predefinable axial distance from one another. The screw body 10 consists of a screw head 36 which is connected to the body in one piece and forms a rotary-drive part for engagement of an actuating tool which is not shown in further detail. Furthermore, the screw body 10 comprises a thread 30 which is connected in one piece to the body and forms a securing part for installation in a housing 42.

The rupture device 12 is an annular rupture disc 18 and the inspecting device 14 is formed by a plug-like sight glass 20, which is inserted in the channel 16 flush towards the outside. The annular rupture disc 18 is fixed to the securing device at one free end face of the channel 16, for example welded accordingly along an annular connecting point 22. Furthermore, the rupture disc 18 comprises a protrusion running in a convex manner from the outside to the inside as a curvature 24, which protrudes into the channel 26 symmetrically with respect to a longitudinal axis 26 of the securing device, wherein the ends of the protrusion or curvature 24 respectively end flush with the free end face of the channel 16 and, as such, transition in one piece into the flat contact surface 28 of the rupture device 12, which, as shown in FIG. 2, runs in a horizontal plane transversely with respect to the longitudinal axis 26.

The protrusion is ultimately the part of the rupture device 12, which is the component that ruptures in the event of overloading or failure. At the location of the annular weld seam 22, the contact surface 28 of the rupture disc 18 emerges into a threaded section 30 connected upwards such that the securing device in its entirety is designed as a kind of securing screw 32 with the threaded section 30 as the actual screw-in part 33 in the form of a male thread 34, which is not reproduced in detail in FIG. 1 for the sake of simplicity. Furthermore, the top of the securing screw 32 comprises an engagement part 36 in the form of a hexagon at the connection to the screw-in part 33, said hexagon serving to engage an assembly tool which is not shown in further detail, such as, for example, a wrench of the appropriate nominal size. As usual with such securing screws 32, the top engagement part 36 protrudes over the bottom screw-in part 33 on the outer circumference. In the direction of the engagement part 36, the threaded section 30 or the male thread 34 respectively emerges into a circumferential groove 38, which serves to receive a sealing means, for example in the form of a copper sealing ring (not shown). The screw body 10 is designed as a compact model, i.e. the nominal size of the screw head 36 substantially corresponds to the overall construction height of the securing screw 32 such as to provide a kind of cuboid structure that is able to withstand particularly high pressures.

The sight glass 20 consists of a glass material, for example made of borosilicate glass, wherein, to establish the connection between the sight glass 20 and the metallic material of the screw body 10, both the glass material and the metallic material are heated together to a temperature at which the glass material is liquid and runs onto the metallic material of the screw body 10 in contact with said material, such that, when it subsequently cools down, the glass material sets inside the channel 16 of the screw body 10 and is clamped by the metallic material in an annular manner and as such is secured in a defined manner. As is also shown in FIGS. 1 and 2, the sight glass 20 ends flush with the upper side of the engagement part 36 and the sight glass 20 is designed as a solid glass cylinder and has an engagement depth in the channel 16 which is somewhat larger than the free diameter of the sight glass 20.

To ensure that the screw body 10 is able to receive fluid accordingly after the rupture device 12 ruptures, the free length of the channel 16, viewed in the parallel direction to the longitudinal axis 26, in the screw-in part 33 is selected to be larger than the outer length of the male thread 34 of the screw-in part 33 which thus surrounds the channel 16, which is designed to be hollow-cylindrical, concentrically.

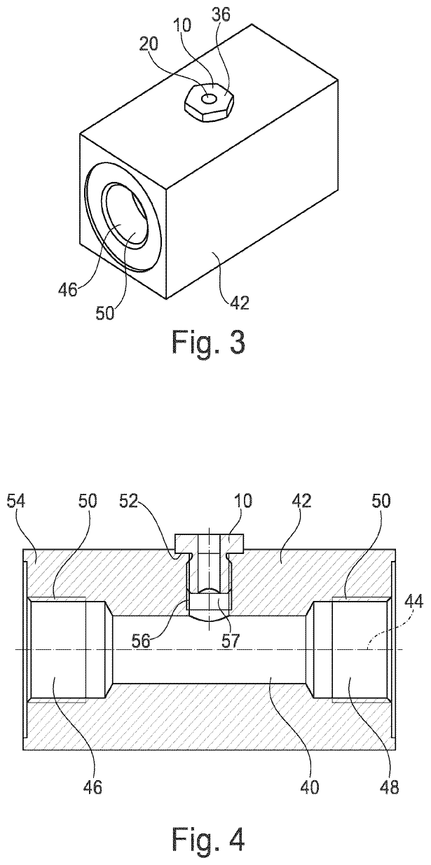

The safety device explained above is particularly suitable for installation in hydraulic components of any kind that are equipped with at least one pressurised fluid channel 40. By way of example and for ease of illustration, such a hydraulic component is reproduced in FIGS. 3 and 4 as a cuboid housing 42, along the longitudinal axis 44 of which the fluid channel 40 runs. The housing 42 may have two fluid connection points, for example in the form of a fluid inlet 46 and in the form of a fluid outlet 48. Both the inlet 46 and the outlet 48 are furnished with a female thread 50, which in each case allows piping, which is not shown in further detail, of a hydraulic circuit with hydraulic components to be connected, such as, for example, a pressure supply pump, a hydraulic accumulator, a valve device, a hydraulic consumer, such as an actuator, etc.

As is also shown in FIG. 3 and FIG. 4, the safety device with the screw body 10 is attached in a central position on the housing 42, wherein the engagement part 36 can be partially screwed flush into a recess 52 on the upper side of the housing 42. The safety device component designed as a screw-in part 33 is screwed with its male thread 34 into a corresponding female thread 56 in the upper housing wall 54 of the housing 42, wherein the female thread 56 forms a longer threaded section than the corresponding male thread 34 of the securing device. In particular, the lower end of the securing device with the rupture disc 18, viewed in the radial direction, is received transversely with respect to the longitudinal axis 44 opposite the fluid channel 40 somewhat set back in the upper housing wall 54. In this process, the lower side of the screw head 36 is supported directly on the housing wall 54, which contributes to secure anchoring of the screw body 10 in the housing 54.

In the event of an undesirable rise in fluid pressure in the fluid channel 40, which may, for example, be sufficient to potentially damage a connected valve device (not shown), such as a pressure- limiting valve, the rupture disc 18 yields by bursting or tearing respectively, and the channel 16 fills with fluid, for example in the form of a coloured hydraulic medium, such as transmission oil. As part of a proposed inspection interval, an operator or maintenance staff member is then able to carry out a visual inspection on the sight glass 20 to ascertain that the channel 16 has filled up with fluid, which is only possible if the rupture disc 18 has yielded and this in turn only yields if an inadmissibly high increase in pressure has been present in the system, even if only for a short period in some cases. If this is reported accordingly, a decision can then be taken whether to carry out a more detailed inspection on the valve device or to replace said valve device immediately. In contrast hereto, a corresponding inspection is not possible in this manner with safety devices according to the prior art.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the function of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

What is claimed is:

1-10. (canceled)

11. A safety device consisting of a screw body with a screw head, which is connected to the screw body in one piece and forms a rotary-drive part, and with a thread, which is connected to the screw head in one piece and forms a securing part, and also with a rupture device, which is arranged in a channel of the screw body, wherein a sight glass is accommodated entirely within the channel of the screw body, together with the rupture device, and forms an inspecting device for assessing the state of the rupture device.

12. The safety device of claim 11, wherein the rupture device comprises a rupture disc, which is securely connected to the screw body in a channel thereof as an independent component, in particular securely welded along an outer circumferential line of the rupture disc.

13. The safety device of claim 12, wherein the rupture disc spans a free end of the channel on the inside, said end being adjacent to a thread runout, which is arranged on the side of the screw body facing away from the screw head.

14. The safety device of claim 12, wherein the rupture disc is furnished with a curvature originating from the securing point of said rupture disc in the channel of the screw body, said curvature protruding in the direction of the sight glass.

15. The safety device of claim 11, wherein the channel is formed by a hollow-cylindrical recess in the screw body, which passes completely through the screw body, retaining the same diameter, and emerging into the environment at its free ends which are opposite one another.

16. The safety device of claim 12, wherein the diameter of the rupture disc and the diameter of the sight glass, which is preferably designed to be cylindrical, is identical.

17. The safety device of claim 11, wherein the sight glass is configured as a solid cylinder and, when inserted in the channel, ends flush with the upper side of the screw head and has an insertion length in the channel such that the sight glass, in a notional extension, ends flush at the level of a (lower) side of the screw head which is adjacent to and opposite a further runout of the thread.

18. The safety device of claim 11, wherein the screw body is formed of a metallic material, which surrounds the glass material of the sight glass, which, together, are heated to a temperature at which the glass material is liquid or paste-like and runs onto the metallic material in contact with said material such that, when it subsequently cools down, the glass material sets inside the channel of the screw body and is clamped by the metallic material in an annular manner.

19. The safety device of claim 11, wherein the sight glass is formed of a glass material, such as
a laminated safety glass,
a soda-lime glass,
a borosilicate glass,
a glass ceramic, or
a quartz or sapphire glass.

20. A hydraulic component with a housing in which at least one pressurised fluid channel runs and having a safety device, which is secured in a pressure-tight manner in the housing and, lying on the housing with its screw head, establishes a fluid-conveying connection the rupture between device and the pressurised channel such that, if a safety-critical threshold pressure value in the fluid channel is exceeded, the rupture device yields and fluid passed into the safety device can be ascertained through the sight glass.

21. The hydraulic component of claim 20, wherein the safety device comprises a screw body with a screw head, which is connected to the screw body in one piece and forms a rotary-drive part, and with a thread, which is connected to the screw head in one piece and forms a securing part, and also with a rupture device, which is arranged in a channel of the screw body, wherein a sight glass is accommodated entirely within the channel of the screw body, together with the rupture device, and forms an inspecting device for assessing the state of the rupture device.

22. The hydraulic component of claim 21, wherein the rupture device comprises a rupture disc, which is securely connected to the screw body in a channel thereof as an independent component, in particular securely welded along an outer circumferential line of the rupture disc.

23. The hydraulic component of claim 22, wherein the rupture disc spans a free end of the channel on the inside, said end being adjacent to a thread runout, which is arranged on the side of the screw body facing away from the screw head.

24. The hydraulic component of claim 22, wherein the rupture disc is furnished with a curvature originating from the securing point of said rupture disc in the channel of the screw body, said curvature protruding in the direction of the sight glass.

25. The hydraulic component of claim 21, wherein the channel is formed by a hollow-cylindrical recess in the screw body, which passes completely through the screw body, retaining the same diameter, and emerging into the environment at its free ends which are opposite one another.

26. The hydraulic component of claim 22, wherein the diameter of the rupture disc and the diameter of the sight glass, which is preferably designed to be cylindrical, is identical.

27. The hydraulic component of claim 21, wherein the sight glass is configured as a solid cylinder and, when inserted in the channel, ends flush with the upper side of the screw head and has an insertion length in the channel such that the sight glass, in a notional extension, ends flush at the level of a (lower) side of the screw head which is adjacent to and opposite a further runout of the thread.

28. The hydraulic component of claim 21, wherein the screw body is formed of a metallic material, which surrounds the glass material of the sight glass, which, together, are heated to a temperature at which the glass material is liquid or paste-like and runs onto the metallic material in contact with said material such that, when it subsequently cools down, the glass material sets inside the channel of the screw body and is clamped by the metallic material in an annular manner.

29. The hydraulic component of claim 21, wherein the sight glass is formed of a glass material, such as
a laminated safety glass,
a soda-lime glass,
a borosilicate glass,
a glass ceramic, or
a quartz or sapphire glass.
